(19) United States
(12) Patent Application Publication
(10) Pub. No.: US 2010/0287098 A1
(43) Pub. Date: Nov. 11, 2010

(54) ELECTRONIC PAYMENT METHOD OF PRESENTATION TO AN AUTOMATED CLEARING HOUSE (ACH)

(75) Inventors: Seng Heng Quek, Singapore (SG); Kwee Inn Koh, Singapore (SG); Teck Hong Lim, Singapore (SG); Hui Ling Wong, Singapore (SG); Heng Hal Lim, Singapore (SG)

Correspondence Address: OHLANDT, GREELEY, RUGGIERO & PERLE, LLP, ONE LANDMARK SQUARE, 10TH FLOOR, STAMFORD, CT, 06901, US

(73) Assignees: Banking Computer Services Private Limited; BCS Information Systems PTE, Ltd.

(21) Appl. No.: 12/811,575

(22) PCT Filed: Jan. 6, 2009
(86) PCT No.: PCT/SG09/00011

§ 371 Date: Jul. 2, 2010

(30) Foreign Application Priority Data
Jan. 9, 2008 (SG) 200800218-0

(51) Int. Cl. G06Q 40/00

(52) U.S. Cl. 705/42

(57) ABSTRACT

An electronic payment method implemented as an application gateway between a bank and an automated clearing house (ACH) which facilitates presentation of complete payment particulars to said ACH of a request for payment from a payor to a payee. Our method requires each of payor and payee to separately input their respective particulars to complete said payment particulars for presentation to the ACH, wherein each of said payor and payee are only allowed selective access to particulars sufficient to identify the transaction. A payor initiates payment request via his bank's electronic banking channel having access to said application gateway. Partial payment particulars are provided which includes a payee identifier. The payee receives a unique code enabling him to access the application gateway via his bank's channel and complete his part of the payment particulars. The complete particulars are presented to the ACH for clearance.

### TECHNICAL FIELD

The present invention concerns an electronic payment method of presenting payment particulars to an automated clearing house (ACH) for clearance. The method may be embodied in an application gateway which interfaces an existing electronic banking system to an ACH.

### BACKGROUND ART

To facilitate automatic electronic debiting and crediting between financial institutions, a computer-based clearing and settlement facility known as the Automated Clear House (ACH) is formed, in an analogous manner to the central clearing house for cheques. A cardinal rule of the ACH is a transaction to the house for clearance can only be issued by a bank upon receiving proper authorization from an account holder—whether it be debit or credit.

It follows that to constitute full authorization, details of both the payor and payee, including their bank accounts and other banking information must be presented. Examples of private information undesirably disclosed may include identity card numbers, birthdates, private phone numbers, etc.

To draw up such complete transaction information, one party (typically the merchant) will provide his portion of the requisite information to the other party (typically the customer) so that the transaction's full information may be completed. Upon successful completion of the transaction, the details of the debiting and/or crediting may be furnished to both parties, thus rendering the private details of one party available to the other. The requirement to furnish these private information is of particular concern if the transaction is between 2 individuals.

There are arrangements whereby privacy of one party is secured from being released to the other party, but usually this is only in respect of the customer, such as that proposed in U.S. Pat. No. 7,092,916 (Diveley) whereby the customer's particulars remain anonymous. Another disadvantage of existing clearing house arrangement is apart from requiring the merchant to disclose his banking details such as his particular bank and bank account number, the merchant is also unable to choose another bank account to use for the business transaction.

### SUMMARY OF DISCLOSURE

It would thus be desirable to have an electronic payment method in which both individual and corporations can initiate and receive payment electronically in such manner so that their respective private and banking details need not be disclosed to each other and yet enable to be furnished to complete an ACH transaction to be cleared successfully. It would be ideal if a proposed method could be achieved by leveraging on the existing electronic banking infrastructure and technologies.

Accordingly, it would be ideal to provide for an electronic payment method between a payor and a payee in respect of a transaction for presenting complete payment particulars to an automated clearing house (ACH) in which each of payor and payee are required to separately input their respective portions of the particulars, to collate the two separate sets of particulars into a complete payment particulars for presentation to the ACH. In addition, each of said payor and payee are only allowed access to particulars that is sufficient to identify the transaction.

In accordance with the general embodiment of our invention, an electronic payment method is implemented as an application gateway between a bank and an automated clearing house (ACH) facilitating presentation of complete payment particulars to said ACH of a request for payment from a payor to a payee, comprising the steps of:
(i) a payor initiating request for payment via the bank's electronic banking channel having access to said application gateway, and providing partial payment particulars which includes payee identifier;
(ii) said electronic banking channel processes said partial payment particulars to approve or reject said request for payment;
(iii) upon approval, sending said partial payment particulars to said application gateway;
(iv) said application gateway generating a unique code to the payee and/or payor;
(v) said payee using said unique code and payee identifier to access said application gateway to complete payment particulars, including indicating a payee bank account particulars for said payment to be credited into;
(vi) said application gateway presenting complete payment particulars to the automated clearing house (ACH).

Preferably, the payee identifier is the payee's name. The payee, upon accessing the application gateway, preferably identifies the payment with a payor identifier. Most preferably, the partial payment particulars accessible to the payee for completion omits particulars deemed private to the payor from the payee.

As an alternative embodiment, certain steps of our method may be ordered differently.

In a preferred embodiment, the payee uses the unique code and payee identifier to access the application gateway via an electronic banking channel of payee's bank, which may include any one or combination of:
instructions over the counter executed by the bank's branch over the bank's electronic banking system;
mobile phone banking portal;
internet banking portal; and
automatic teller machines (ATM) and banking kiosks.

In one aspect of the invention, the payor initiates request for payment to multiple payees in a batch instruction to the application gateway by implementing steps (iv) onwards in respect of each of the payee.

Preferably, the electronic banking channel's communication with the application gateway is conducted via a closed network. Preferably still, the electronic banking channel provides a redirection to the application gateway for the ease of payor and/or payee to furnish requisite inputs to the application gateway while accessing said electronic banking channel.

In another aspect of our invention, the clearing and settlement instructions are processed on-the-fly in batch mode. Preferably, the payment request may be postdated and data-warehoused accordingly. Another preferable feature is wherein the payment request may be stopped by the payor. As with conventional electronic banking channel, at least a 2-factor authentication is used to identify a payor and payee in our method.

In yet another aspect of our invention, the payment request may include a guaranteed form of payment of funds including positive pay acknowledgement, earmarking funds and the like. Our afore-described method may also be implemented for reward redemption by merchants.

Another embodiment of our invention is to provide a foreign currency exchange module for cross-border transactions.

Apart from being embodied as a specific embodiment described herein as an application gateway providing interfacing between electronic banking channels and an ACH, we would reiterate that the essential feature of our invention lies in providing an electronic payment method between a payor and a payee in a transaction whereby complete payment particulars has to be furnished to an automated clearing house (ACH), our novelty lies in requiring each of payor and payee to separately input their respective particulars to complete said payment particulars for presentation to the ACH, wherein each of said payor and payee are only allowed selective access to particulars sufficient to identify the transaction.

### LIST OF ACCOMPANYING DRAWINGS

The foregoing aspects and embodiments of our method may be better understood by referring to the following drawings and the subsequent detailed description. It should be noted that these drawings exemplify in a non-limiting manner only certain embodiments of our invention, in which—

FIG. 1 shows a simplified graphical representation of our method as an application gateway interfacing a bank's electronic banking channels to an ACH;

FIG. 2 illustrates a simplified graphical representation of our method in respect of an internet banking portal channel to an ACH;

FIG. 3 depicts an example of a screen display for a payor to request payment via his bank's internet banking portal;

FIG. 4 shows examples by which the unique code is sent to a payee in order to access our application gateway to retrieve and furnish payee's particulars;

FIG. 5 illustrates an example of a screen display for a payee to accept payment via his bank's internet banking portal;

FIG. 6 depicts an example of a screen display for a payee to pre-register with the application gateway via payee bank's internet banking portal;

FIG. 7 shows an example of a screen display for a payor to pre-register with the application gateway via payor bank's internet banking portal;

FIG. 8 illustrates a high level overview of a corporate payment flow according to a method of our invention;

FIG. 9 depicts a schematic overview of a reward voucher redemption scheme according to a method of our invention;

FIG. 10 shows an example of a screen display of a dialog box of our application gateway which has been redirected from a banking channel;

FIG. 11 shows an example screen display of listing of outstanding payment instructions pending clearance which the payor may stop or suspend payment;

FIG. 12 illustrate an example of a screen display showing details of pending payment which may be subject to the stop or suspend payment request and to notifying the payor and/or payee; and

FIG. 13 depicts a logic flow of earmarking a payment transaction according to one embodiment of our invention.

### DETAILED DESCRIPTION OF SPECIFIC EMBODIMENTS

Among the key features of our method for an electronic payment method implemented as an application gateway between a bank and an automated clearing house (ACH) in which the presentation of complete payment particulars to the ACH may be made are as follows:
anonymity of both payor and payee information;
concurrent notification to parties upon payment creation and collection;
payment tracking;
additional information for payment between payor and payee to describe;
bulk payment of fund without payee information; and
quick turnover.

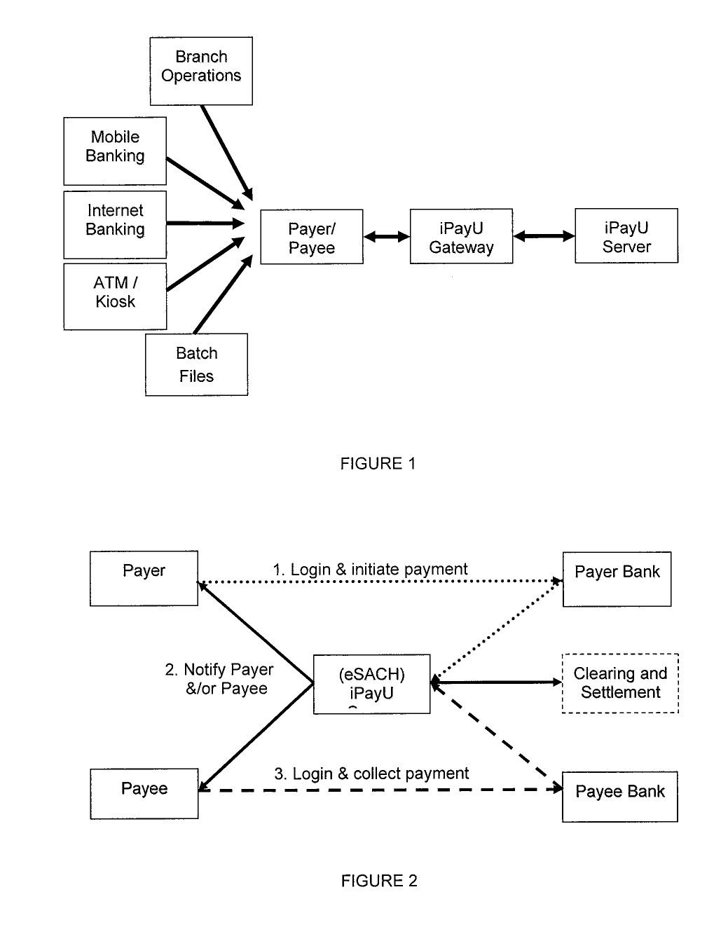

As an application gateway deployed between the banks and the Automated Clearing House (ACH). The payor may initiate payment instructions from various electronic banking channels as long as the bank provides an interface from that channel to the gateway as shown in FIG. 1. Our method is able to support transactions initiated from the various existing electronic banking channels offered by the banks such as ATM, banking kiosk, Internet banking, phone banking or over the counter at bank's branches.

An example of a channel in the form of a peer-to-peer transactions via an Internet banking channel is shown in FIG. 2.

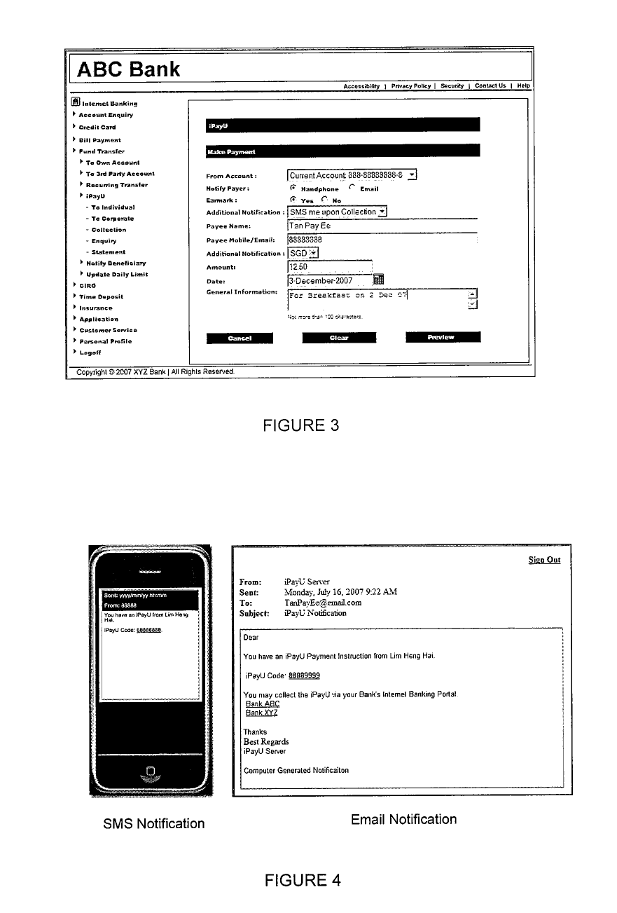

After logging into the bank's IB, the payor indicates the payment information as shown in FIG. 3 by filling in the fields of the record as required. It should be noted that the only particulars of the payee that the payor needs to fill up is the payee's name and his contact (i.e. either mobile phone number or text-capable fixed line number, or his email) so that notification from the application gateway could be sent to him. Such phone numbers would be the ones the merchant choose to publicize as part of his conduct of business rather than private numbers. It can be seen here that other private details of the payee such as his bank name and account number are not required.

After the payment instruction is created successfully, the information is sent to the application gateway server via a closed network. The application gateway server will send a unique code to the payee and/or payor. In FIG. 4, it is shown two examples of sending the unique code to the payee, i.e. by SMS text to a mobile phone or fixed line phone with texting capability, and by email.

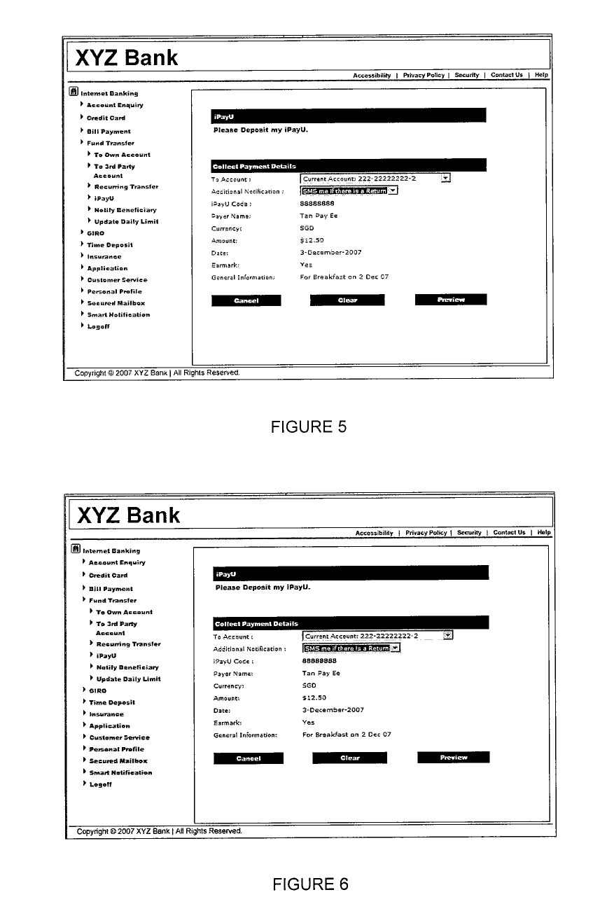

The payee may use the unique code to retrieve the payment record, shown as an example dialog box display in FIG. 5, from the application gateway server via the payee's bank Internet banking portal or other channels provided by the bank. The payment record may be correctly identified by the payee's name or some other unique identifier, so that after inputting the unique code and only if the payee name (or some other identifier) matches the record in payee bank, the payment record will be retrieved and selectively displayed to the payee for his part of completing the particulars. The payee can at this stage select the account that he wants to deposit the payment.

As illustrated, the payee need not reveal his banking information to the payor. In fact, he does not need to decide which of his bank accounts to use for the transaction. In addition, both the payor and payee need not fear that they have input the wrong account information as the account information is listed in the system. Once the payment is presented, the payment instruction will be automatically sent for clearing.

Our proposed method also allows the payor to post-date their transaction. To allow users to post-date their transactions, our application gateway server can data-warehouses or operational data storing the transactions and only present the transactions on the pre-determined date to be cleared. Once the transaction is created, our application gateway server will warehouse the transactions. At a pre-configured time daily, our application gateway server will send the unique code to the Payee on the post-dated date. The Payee can then collect the payment via their existing Bank's channels.

Provision is also made to have a description field whereby the parties can specify a description or reason for the payment. This feature will be useful for records and accounts reconciliation purposes.

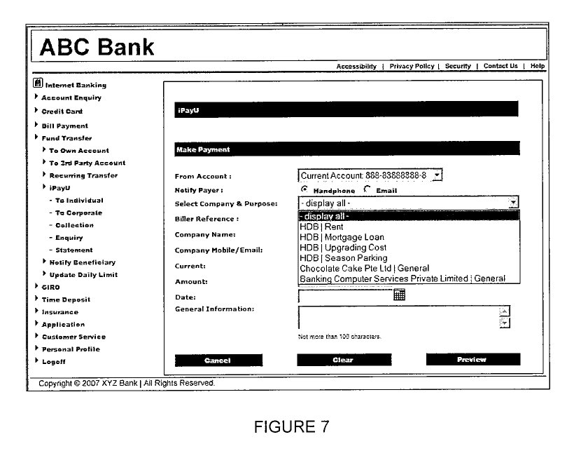

In order to support existing online payment features such as bills payment, our application gateway proposes allowing corporations and merchants to pre-register their billing information as shown in FIG. 6. After registering the information with the application gateway server, the information will be made available to the individual banks participating in the system. The information will be listed in a drop-down list as shown in FIG. 7.

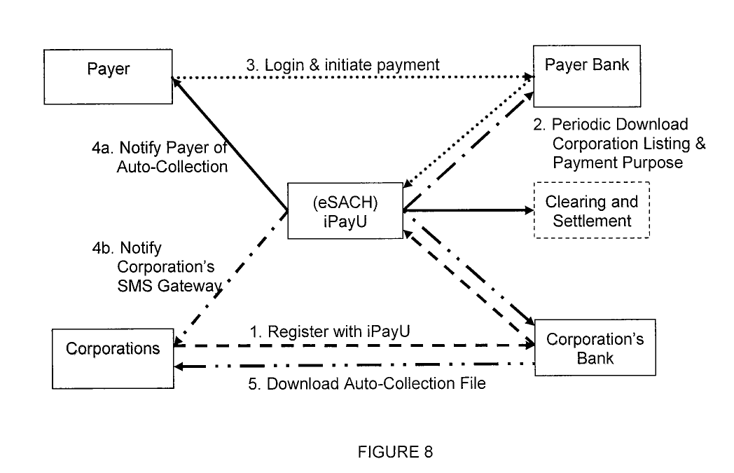

A high-level overview of corporate payment flow is shown in FIG. 8. Besides paying to a corporation that is pre-registered with the application gateway server, our system also allows the payor to pay a corporation that is not registered with the server, i.e. just like in the initial example of paying an individual. The payor only needs to input the corporation name and valid contact information (mobile phone number or fixed line phone with texting capability, or email).

Similar to the peer-to-peer solution, the banking information of the payor is not released to any parties. Our proposed method allows a corporation to receive the acknowledgement to confirm the payment immediately via SMS. If it does not select the option, the corporation can collect the information via their bank.

In a conventional ACH, large volumes of debit and credit transactions are cleared in batches, i.e. in batch mode. With the current payment instruments, the payee will need to provide his private banking information so that the corporation can make individual payments to each of them. If the information is unavailable, the corporations and government agencies will need to send cheques to each of the payees. In our proposed method, a batch file feature is provided to allow corporations and government agencies to make or receive bulk payments to multiple payees or from multiple payors. Our application gateway server can generate a batch file with all the unique codes and sent it to the corporations via their respective banks. The corporations and government agencies can print the unique codes on their notification letters to each of the payees and the payees can use the unique codes to access the application gateway server to collect the payments.

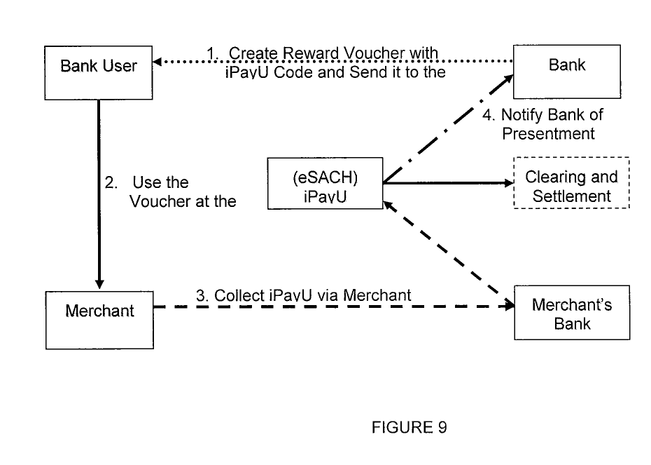

As another feature, a bank participating with our application gateway may create a reward voucher with unique codes for their credit card reward redemption or other reward or loyalty program. A simplified graphical representation is shown in FIG. 9. When a customer rewarded by the bank presents the voucher to participating merchants for redemption, the merchants can present the unique codes immediately to their banks for settlement. With the solution, merchants can collect their payment for the reward redemption electronically immediately after settlement rather than at the end of the month.

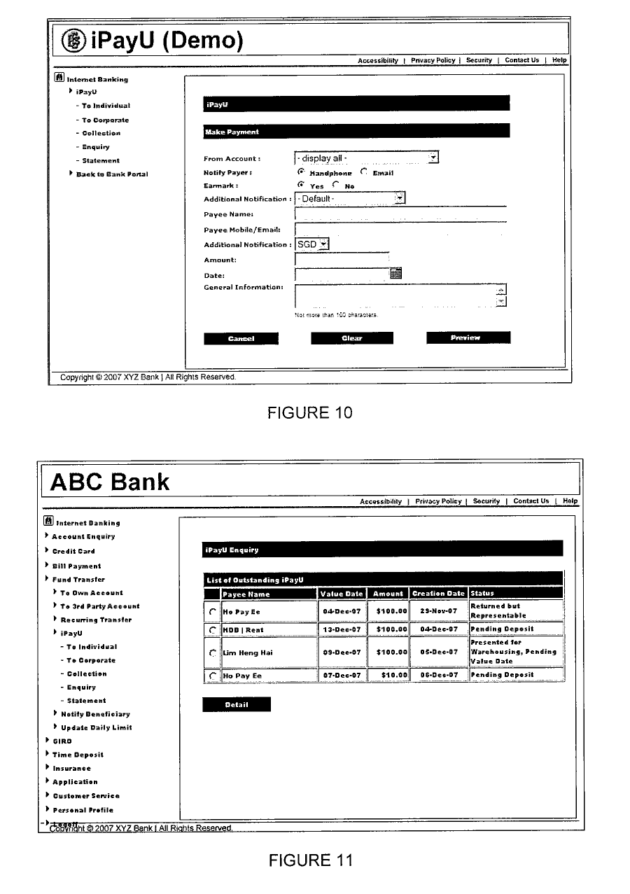

In order to minimize the development efforts of the banks, our method also provides an option for bank to redirect their customers accessing their existing electronic banking channels to be redirected to a common application gateway portal which example of a dialog box is shown in FIG. 10.

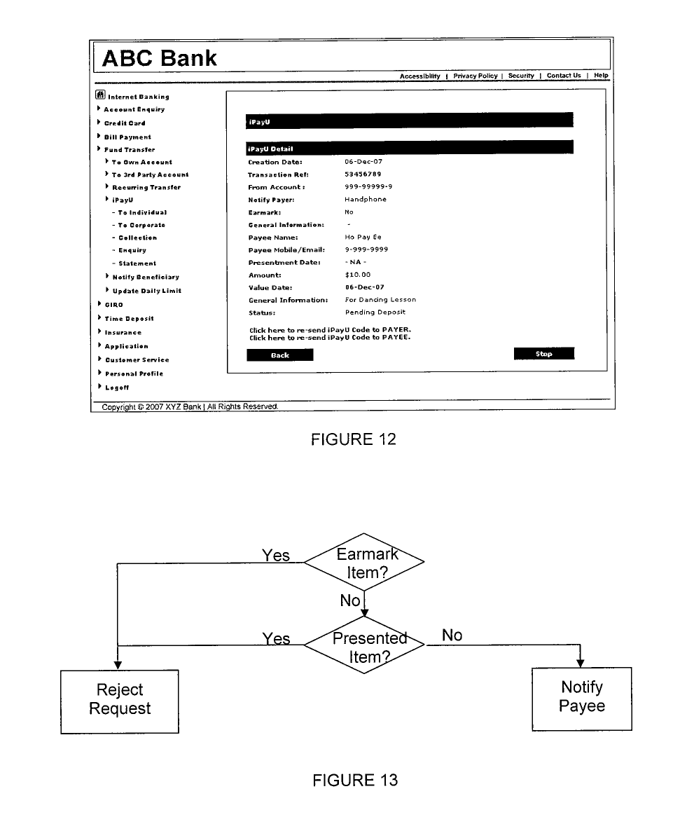

Another proposed feature is enabling the payor to stop or suspend payment via the same channels provided by the payor bank. Currently, a payor will need to decide before hand the specific payment instructed (but pending clearance) to be stopped or suspended. With our application gateway, a list of all the payments instructed by the payor which are pending clearance may be listed as shown in FIG. 11. If, for example, a stop or suspend payment action is desirable due to payor's insufficient funds or due to payee's inadequate supply (including quality) of goods or services, then the payor's pending payments may be listed or collated in a manner that would assist the payor in deciding which specific payment(s) is/are to be stopped to overcome the aforesaid inadequacy. Details such as the particular stage of processing or clearance may be displayed for each payment as shown in FIG. 12. In addition, the Payer can stop or re-send notification to the Payee using the listing as shown.

As with conventional stop payment instructions, it is not guaranteed to work and is subject to timely execution or intervention. After the Payer has submitted the stop payment request, our application gateway will perform a check on the success of the stop request before notifying the payer on the status. If the request is unsuccessful, the payer would be notified. If the requested is processed successfully, both the Payer and Payee would be notified unless it is a post-dated transaction. For post-dated transaction, the Payee would only be notified if the request is submitted on or after the “post-dated” date. A logic flow of such process is shown in FIG. 13.

As our proposed application gateway is to be built on top of the existing electronic banking channels, the current security features such as 2-factor authentication for Internet banking, will enable our method to be as secured as these channels. As such, the likelihood for the payee to have compromised their unique code to a person having the same name with an intended payee is very low. Even if the scenario occurs, as the transactions are cleared in the present ACH and respective banking system, it will be easy to trace the person.

Another feature is similar to a cheque in which the payee can request for a marked cheque services. In our method, the Payee can perform it at anytime and anywhere via Internet banking or phone banking. Once the payment is marked, our application will check if the payor has sufficient fund to make the particular payment. The payee is thus guaranteed the receipt of the fund once the payor bank replies a positive acknowledgement. A similar alternative is to earmark the payment. This arrangement guarantees the payee the receipt of the fund. It is especially useful for corporation payment or bill payment collection or payment versus delivery services. In addition, the bank can also allow the payee to encash the money before it is settled at the end of the day as the fund is guaranteed.

Many other electronic banking features will also be made available in our proposed application gateway and method. For instance, an enquiry module may enable a payor to enquire the status of the payment via the application gateway. In addition, the payor can also use the module to stop payment or request for the resending of the unique code to either the payor or payee. An electronic statement feature that is available online or in print may allow the user to have a consolidated view of all the payment and receipt in a specific period. This feature will be useful for corporations to reconcile the financial statement at the end of their financial period.

A payment tracking may be established to track the status of all instructions under our method processed via the application gateway from the time payments are created till payments are collected. As another feature, as both the account information of the payor and payee is available at the application gateway server, the banks can minimize their implementation cost by using the posting file provided by the solution to provide the account posting at the end of the day.

Under an auto-collection feature, our invention also allows payment to registered corporation to be presented immediately upon creation. The feature is effectively an electronic lock-box for a corporation that will be cleared immediately after payor creates a payment to the corporation. In order to support online payment and even normal bill payment, our application gateway server allows corporations to pre-register their billing information. The corporation can specify different accounts for payments received for different purposes. The payments made by the payer for different purposes would be automatically collected into the pre-designated accounts specified by them during the registration as shown in FIG. 12. This is equivalent to an electronic lock-box feature for the corporation.

Finally, a forex module may be added to support multiple currencies transactions with the addition of currency code for all transactional data. This module will support cross-border transactions with the addition of a foreign exchange module.

Our method also provides for a Clearing and Settlement module that is a fully-automated solution for clearing payment instructions on our application gateway on-the-fly or in batch mode.

As our method and application gateway is proposed to be interfaced between the banks' existing electronic banking channels and the ACH, it will be obvious to a skilled person that many of the features of our method as described above may be adapted or modified accordingly or coupled with conventional modules, processes or routines. These are not to be considered as departures from the letter and scope of our invention as defined in the following claims.

1. An electronic payment method implemented as an application gateway between a bank and parties to a payment transaction facilitating presentation of complete payment particulars of said payment transaction from a payor to a payee to be cleared by an automatic clearing house (ACH), such that partial payment particulars provided by each of said payor and payee may be collated into complete payment particulars required by the ACH to process and clear said transaction, said method comprising the steps of:
(i) a payor initiating request for payment via the bank's electronic banking channel having access to said application gateway, and providing partial payment particulars which includes payee identifier;
(ii) said electronic banking channel processes said partial payment particulars to approve or reject said request for payment;
(iii) upon approval, sending said partial payment particulars to said application gateway;
(iv) said application gateway generating a unique code to the payee and/or payor;
(v) said payee using said unique code and payee identifier to access said application gateway to complete payment particulars, including indicating a payee bank account particulars for said payment to be credited into;
(vi) said application gateway presenting complete payment particulars to said automatic clearing house (ACH) be cleared.

2. (canceled)

3. An electronic payment method according to claim 1 wherein the payee identifier is the payee's name.

4. An electronic payment method according to claim 1 wherein the payee, upon accessing the application gateway, identifies the payment with a payor identifier.

5. An electronic payment method according to claim 1 wherein the partial payment particulars accessible to the payee for completion omits particulars deemed private to the payor from the payee.

6. An electronic payment method according to claim 1 in the same order of steps as listed.

7. An electronic payment method according to claim 1 wherein the payee uses the unique code and payee identifier to access the application gateway via an electronic banking channel of payee's bank.

8. An electronic payment method according to claim 1 wherein the electronic banking channel having access to the application gateway includes any one or combination of:
instructions over the counter executed by the bank's branch over the bank's electronic banking system;
mobile phone banking portal;
internet banking portal; and
automatic teller machines (ATM) and banking kiosks.

9. An electronic payment method according to claim 1 wherein the payor initiates request for payment to multiple payees in a batch instruction to the application gateway by implementing steps (iv) onwards in respect of each of the payee.

10. An electronic payment method according to claim 1 wherein the electronic banking channel's communication with the application gateway is conducted via a closed network.

11. An electronic payment method according to claim 1 wherein a party may pre-register with the application gateway server its part of payment or payment receiving transaction particulars and wherein said pre-registered parties are compiled into a list and made available to a party initiating payment.

12. An electronic payment method according to claim 1 wherein the electronic banking channel provides a redirection to the application gateway for the ease of payor and/or payee to furnish requisite inputs to said application gateway while accessing said electronic banking channel.

13. An electronic payment method according to claim 1 wherein the clearing and settlement instructions are processed on-the-fly in batch mode.

14. An electronic payment method according to claim 1 wherein the payment request may be postdated and data-warehoused or operational data stored accordingly.

15. An electronic payment method according to claim 1 wherein the payment request may be stopped by the payor.

16. An electronic payment method according to claim 1 wherein at least a 2-factor authentication is used to identify a payor and payee.

17. An electronic payment method according to claim 1 wherein the payee's bank account number in step (v) is predetermined by the payee at the application gateway whereby payment instructions from the payer may be designated for receiving into said predetermined account without such further input from payee.

18. An electronic payment method according to claim 1 wherein the payment request includes a guaranteed form of payment of funds including positive pay acknowledgement, earmarking funds and the like.

19. An electronic payment method according to claim 1 implemented for reward redemption by merchants.

20. An electronic payment method according to claim 1 further including a foreign currency exchange module for cross-border transactions.

21. An electronic banking channel, including at least one selected from the group consisting of:
inter-branch internal banking network;
mobile phone banking portal;
internet banking portal; and
automatic teller machines (ATM) and banking kiosks,
wherein said electronic banking channel is an electronic payment method implemented as an application gateway between a bank and parties to a payment transaction facilitating presentation of complete payment particulars of said payment transaction from a payor to a payee to be cleared by an automatic clearing house (ACH), such that partial payment particulars provided by each of said payor and payee may be collated into complete payment particulars required by the ACH to process and clear said transaction, said method comprising the steps of:
(i) a payor initiating request for payment via the bank's electronic banking channel having access to said application gateway, and providing partial payment particulars which includes payee identifier;
(ii) said electronic banking channel processes said partial payment particulars to approve or reject said request for payment;
(iii) upon approval, sending said partial payment particulars to said application gateway,
(iv) said application gateway generating a unique code to the payee and/or payor;
(v) said payee using said unique code and payee identifier to access said application gateway to complete payment particulars, including indicating a payee bank account particulars for said payment to be credited into;
(vi) said application gateway presenting complete payment particulars to said automatic clearing house (ACH) be cleared.

22. An application gateway implementing said electronic payment method according to claim 1.

23. An electronic payment system incorporating at least one selected from the group consisting of:
an electronic banking channel, including at least one selected from the group consisting of:
inter-branch internal banking network;
mobile phone banking portal;
internet banking portal; and
automatic teller machines (ATM) and banking kiosks,
wherein said electronic banking channel is an electronic payment method implemented as an application gateway between a bank and parties to a payment transaction facilitating presentation of complete payment particulars of said payment transaction from a payor to a payee to be cleared by an automatic clearing house (ACH), such that partial payment particulars provided by each of said payor and payee may be collated into complete payment particulars required by the ACH to process and clear said transaction, said method comprising the steps of:
(i) a payor initiating request for payment via the bank's electronic banking channel having access to said application gateway, and providing partial payment particulars which includes payee identifier;
(ii) said electronic banking channel processes said partial payment particulars to approve or reject said request for payment;
(iii) upon approval, sending said partial payment particulars to said application gateway;
(iv) said application gateway generating a unique code to the payee and/or payor;
(v) said payee using said unique code and payee identifier to access said application gateway to complete payment particulars, including indicating a payee bank account particulars for said payment to be credited into;
(vi) said application gateway presenting complete payment particulars to said automatic clearing house (ACH) be cleared,
an application gateway implementing an electronic payment method between a bank and parties to a payment transaction facilitating presentation of complete payment particulars of said payment transaction from a payor to a payee to be cleared by an automatic clearing house (ACH), such that partial payment particulars provided by each of said payor and payee may be collated into complete payment particulars required by the ACH to process and clear said transaction, said method comprising the steps of:
(i) a payor initiating request for payment via the bank's electronic banking channel having access to said application gateway, and providing partial payment particulars which includes payee identifier;
(ii) said electronic banking channel processes said partial payment particulars to approve or reject said request for payment;
(iii) upon approval, sending said partial payment particulars to said application gateway;
(iv) said application gateway generating a unique code to the payee and/or payor;
(v) said payee using said unique code and payee identifier to access said application gateway to complete payment particulars, including indicating a payee bank account particulars for said payment to be credited into;
(vi) said application gateway presenting complete payment particulars to said automatic clearing house (ACH) be cleared, and
an automated clearing house (ACH).

24. (canceled)
